(19) United States
(12) Patent Application Publication
(10) Pub. No.: US 2025/0257906 A1
(43) Pub. Date: Aug. 14, 2025

(54) PHASE CHANGE MATERIAL ENHANCED HEAT EXCHANGER

(71) Applicant: Highmark NY, LLC, New York, NY (US)

(72) Inventors: Drew Lawrence MAGGIO, Bethpage, NY (US); Richard Edward GERBE, East Northport, NY (US)

(73) Assignee: Highmark NY, LLC, New York, NY (US)

(21) Appl. No.: 19/046,110

(22) Filed: Feb. 5, 2025

Related U.S. Application Data
(60) Provisional application No. 63/551,971, filed on Feb. 9, 2024.

(51) Int. Cl. F24T 10/13; F28D 21/00

(52) U.S. Cl. CPC F24T 10/13; F28D 2021/0019

(57) ABSTRACT

A system with a subterranean borchole, a fluid loop located within the borchole and fluidly coupled to a building energy system of a building, and a thermal material located within the borchole configured to enhance the heat transfer between the fluid loop and the surrounding ground.

### CROSS-REFERENCE TO RELATED APPLICATIONS

This application claims priority in U.S. Patent Application Ser. No. 63/551,971, filed Feb. 9, 2024, the contents of which are hereby incorporated by reference in its entirety.

### BACKGROUND

### 1. Field of the Disclosed Subject Matter

The present disclosure generally relates to the geothermal field. More particularly, the present disclosure relates to a system for enhanced geothermal heat exchange for use in underground heat exchangers.

### 2. Background

Significant attention is being drawn to methods and systems that increase the thermal efficiency of heating, ventilation, and air conditioning (HVAC) system for commercial and residential buildings in pursuit of lowering cost and energy use. One popular approach is to incorporate geothermal heating and cooling systems, which offer considerable advantages in terms of environmental impact and operational efficiency. Geothermal HVAC systems utilize the Earth's relatively stable subsurface temperature to function as a heat sink or thermal source in HVAC systems.

One popular approach to implement a geothermal heating and cooling system with an HVAC system is by way of vertical closed-loop heat exchangers which include one or more boreholes that house one or more closed loops of piping within. Each closed loop circulates a working fluid between the HVAC system and the ground. The working fluid transfers heat between a structure's HVAC system and the ground and can provide reversible heat transfer between the two. The boreholes are typically filled with a filler, such as grout, to stabilize the position of the piping. Due to the relatively low thermal conductivity of the earth, the efficiency of the system can be low.

The above-described background relating to geothermal heat exchangers is merely intended to provide a contextual overview of some current issues and is not intended to be exhaustive. Other contextual information may become apparent to those of ordinary skill in the art upon review of the following description of exemplary aspects.

### SUMMARY

An aspect of the disclosed subject matter pertains to a geothermal heat transfer system comprising a subterranean borehole, a fluid loop of conduit having an inlet thereto and an outlet therefrom with a portion of the loop of conduit disposed in the borehole, and a thermal material disposed in the borehole configured to be in thermal communication with the walls of the borehole and the fluid loop.

A further aspect of the disclosure pertains to providing energy transfer to a structure or building comprising providing a plurality of fluid circuits in communication with a building energy system, providing a thermal material surrounding the plurality of fluid circuits, providing a barrier surrounding the plurality of fluid circuits, and circulating a fluid between the building energy system and the plurality of fluid circuits.

### BRIEF DESCRIPTION OF THE DRAWINGS

The present disclosed subject matter is described herein with reference to the following drawing figures, with greater emphasis being placed on clarity rather than scale:

FIG. 1 is a schematic view of a geothermal heat exchanger system in accordance with aspect of the disclosed subject matter.

FIG. 2 is a schematic view of an exemplary aspect of a geothermal heat exchanger in accordance with an aspect of the disclosed subject matter.

FIG. 3A is a cross-sectional view of another exemplary aspect of a geothermal heat exchanger in accordance with an aspect of the disclosed subject matter.

FIG. 3B is a cross-sectional view of another exemplary aspect of a geothermal heat exchanger in accordance with an aspect of the disclosed subject matter.

FIG. 4 is a schematic view of an exemplary aspect of a geothermal heat exchanger in accordance with an aspect of the disclosed subject matter.

FIG. 5 is a schematic view of an exemplary aspect of a geothermal heat exchanger in accordance with an aspect of the disclosed subject matter.

FIG. 6 is a schematic view of an exemplary aspect of a geothermal heat exchanger in accordance with an aspect of the disclosed subject matter.

FIG. 7 is a cross-sectional view of FIG. 6.

FIG. 8 is a schematic view of an exemplary aspect of a geothermal heat exchanger in accordance with an aspect of the disclosed subject matter.

FIG. 9 is a schematic view of an exemplary aspect of a geothermal heat exchanger in accordance with an aspect of the disclosed subject matter.

### DETAILED DESCRIPTION

The disclosed subject matter includes a type of closed-loop ground heat exchanger. An aspect comprises one or more boreholes that begin at the ground surface and extend in a subterraneous manner. It is envisioned that each borehole can define a subterranean area and a borehole surface that can comprise a jacketed layer, such as a liner. The liner can be formed of any material which can be suitable to provide separation from the borehole and surrounding earth. In some aspects, the liner is a material which can be substantially flexible and can additionally conform to the borehole surfaces. In some aspects, the liner is formed of a polymeric material, such as polyvinyl chloride (PVC) or polyethylene terephthalate (PETE). The liner can be configured to withstand the hydrostatic pressure of the contents of the borehole and withstand penetration from objects, such as sharp rocks. Further, the liner can be configured to support the weight of a U-bend section of the fluid loops. The system can include a cap that can be located at an uppermost section of the borehole that defines the ground level. The cap can be configured to sealingly engage with the borehole. In some aspects, the cap comprises at least one penetration or through hole that permits a building energy system to be in communication with the borehole and/or system. In several aspects, the system can comprise at least one fluid loop within a borehole which can be fluidly coupled to the building energy system of a building and configured to circulate a working fluid therebetween. In some aspects, the building energy system can be, for example and without limitation, a HVAC system.

In some aspects, the system of the present disclosure can comprise a material disposed between the fluid loops and liner configured in thermal communication with the same. The system can undergo a reaction when the building heat pump is operating and rejects heat to the surrounding ground after the system is deactivated. The added material greatly expands the capacity of a single borehole before reaching constraint water temperatures.

In an exemplary aspect of the system according to the present disclosure, a subterranean borehole can be configured to define a void below the ground surface of the earth. It is envisioned that the borehole can be sizably prepared to contain the system. In some aspects, the system comprises at least one fluid loop which can be configured to transport a working fluid from the system to the building energy system of a structure. In an exemplary aspect, the fluid loop is an array of water lines that are configured to circulate water between the system of the present disclosure and the building energy system of a building, wherein the water acts as the medium for heat transfer between the system and the building energy system. In some aspects, the building energy system is an HVAC system. In certain aspects, water can be used as the working fluid, although other coolants and refrigerants are contemplated. In some aspects, the working fluid can comprise a glycol, such as ethylene glycol or propylene glycol. In some aspects, the working fluid can be antifreeze. In some aspects, the thermal material can be a phase change material (PCM), having defined phase change characteristics, such as the PCM provided by Phase Change Solutions, Inc. of Asheboro, North Carolina, Polymer Science, Inc. of Monticello, Indiana, or Insolcorp, LLC of Albemarle, North Carolina. In some aspects, the PCM fluid can be glycol, such as propylene glycol or ethylene glycol. In some aspects, the system can comprise multiple systems (e.g. multiple boreholes and associated components) that are configured to work in unity to optionally maintain an elevated ground temperature on a seasonal time-frame.

In certain aspects, the system further can comprise a thermal material disposed within the borehole. The thermal material can be configured to fill the void between the fluid loops and the walls of the borehole. In some aspects, the thermal material can be configured to stabilize the fluid loops. In some aspects, the thermal material can be configured to increase the thermal conductivity of the surrounding earth and enhance the heat transfer between the fluid loops and the surrounding earth. In some aspects, the thermal material can be configured to store thermal energy.

According to some aspects of the present disclosure, the system can further comprise a cap that engages a ground-level surface of the borehole. It is envisioned that the cap can sealingly engage with the borehole and prevent contaminants, water, and other materials from entering. The cap can be configured to substantially cover an opening of the borehole and can be structurally configured to bear on a surface a load, for example, an additional structure. It is envisioned that in some aspects, the cap can be configured to be removable to provide access to the borehole, for example, to provide maintenance to the borehole or the apparatus therein. In many aspects, the borehole can be configured with one or more supply and return penetrations that provide access to the fluid loops of the borehole. Further, the supply and return penetrations provide fluid communication between the system and/or fluid loops and an external HVAC system.

In some aspects, the system further includes a liner disposed about an outer perimeter of the borehole. It is envisioned that the liner can define the outer surface of the borehole and provide separation between the borehole and the surrounding earth. In some aspects, the borehole is substantially impermeable to fluid transfer between the borehole and the surrounding earth. In some aspects, the liner is substantially flexible and able to deform and distort. In some aspects, the liner is formed of a polymeric material, such as PVC. The liner can be formed of, for example, high-density polyethylene (HDPE), low-density polyethylene, linear low-density polyethylene, ethylene propylene diene monomer, chlorosulfonated polyethylene, polypropylene, thermoplastic olefin, flexible polyolefin, plastisol, or acrylic.

In certain aspect, the fluid loops can be disposed with the borehole and extend substantially vertically. It is envisioned that the loops can form a U-shaped loop that extends in a vertical direction when viewed from a frontal perspective. In other aspects, the loops can extend substantially horizontally or be canted approximately 90 degrees from the vertical position, or any other desired angle or combination of angles in other aspects. In some aspects, the fluid loops can be spaced apart from one another and can define a space therebetween. It is envisioned that in some aspects, the space between the fluid loops can create a void that can be filled by the thermal material. In some aspects, the fluid loops are arranged in an array, wherein the spacing of the array can be optimized to minimize the oversaturation of heat. It is envisioned that the arrays can define a plurality of shapes, such as, for example, circular, rectangular, triangular, or the like. It is further envisioned that the fluid loops can define pipes defining a diameter which can be configurable based on the area of the array such that the heat transfer can be optimized.

In some aspects, the system includes a thermal material disposed within the borehole. The thermal material can be configured to enhance the heat transfer and efficiency of the system. In some aspects, the thermal material is a (PCM. The PCMs can be configured to increase the thermal capacity of the borehole by absorbing additional thermal energy as latent heat during the phase change. In some aspects, the latent heat stored during a phase transition of the PCM can be released into the ground. It is envisioned that the release of heat can occur with or without the system active. Further, it is envisioned that the PCM can be operable to release stored thermal energy after the system or building energy system is switched off.

In some aspects the PCM can be configured to increase the heat transfer between the ground and the boreholes. Specifically in some aspects, it is envisioned that the PCM can be operable to increase the rate of heat transfer between the fluid loops and the surrounding earth. In some aspects, the PCMs can be optimized based on the seasonal conditions of the earth and climate. For example, the system can comprise a separate summer PCM and winter PCM. In addition, the PCMs can enable the arrays to be smaller than standard arrays due to increased heat transfer. In some aspects, the PCM can be a composition of any of thermally expanded graphene, grout, fatty acids, acids, oleic acid, salt hydrates, sodium sulfate decahydrate, magnesium chloride hexahydrate, paraffin waxes, bio PCMs such as triglycerides, or organic compounds such as polyethylene glycols, ice, ice pellets, molten salt, or any other material having a suitable phase change characteristics. In some aspects, the PCM can be a synthetic material or manmade material. In some aspects, the PCM can be a naturally occurring material. In some aspects, the PCM can be loaded into the borehole in liquid form, pellet form, or in a solution such as a water solution. The PCM can be circulated to encourage the settling of the PCM, such as by agitation, vibration, or melting of the PCM.

In some aspects according to the present disclosure, the PCM can be configured to provide greater heating and/or cooling capacity of an building energy system, such as an HVAC system or geothermal loop. In some aspects, the PCM can be operable to facilitate 24/7 heat transfer between the system and building energy system regardless of the operational condition of the building energy system. Further, the PCM can be charged or boosted during shorter seasons. In some aspects, the PCM can be operable to enable overnight heat transfer between the system and the earth.

In some aspects, the system according to the present disclosure can comprise two or more PCMs that have separate thermal properties. It is envisioned that through such use of a plurality of PCMs, asymmetrical heating and cooling loads can be met. In an exemplary aspect, the system can comprise a first PCM whose thermal properties are optimized to increase heat transfer during cooler months and a second PCM whose thermal properties are optimized to increase heat transfer during warmer months. Further, in some aspects, the system can be sectioned into a hot side and a cold side defined by the thermal energy of each section. In some aspects, the system can be a heat pump configured to circulate a fluid between the hot side and the cold side. In some aspects, the PCM can be a material that has multiple phase change characteristics. In some aspects, the PCM can be a material that has one or more melting or freezing temperatures. In some aspects, the system can provide a thermal material that comprises a first set of thermal properties which can be configured to engage during a heating cycle and a second set of thermal properties which can be configured to engage during a cooling cycle. In some aspects, the system can comprise a first PCM having a phase-change temperature above undisturbed ground temperature (for example, 10 degrees Celsius) and a second PCM having a phase-change temperature below undisturbed ground temperature.

In some aspects, the system can comprise a borehole that contains therein two or more PCMs. In some aspects, the system can comprise a borehole configured to separate two or more PCMs. It is envisioned that the system can be operable to separate multiple PCMs by way of, for example, micro/macro encapsulation of one PCM which can be suspended with another PCM or both suspended in an intermediary fluid such as water. In some aspects, multiple PCMs are separated by one or more chambers disposed within the borehole. In some aspects, a plurality of boreholes can be provided that each have separate PCM types. In some aspects, the phase change temperature of the PCM can be aligned near the standard water temperature of a building, such as the thermal loop temperatures of the building energy system components. In some aspects, the PCM can be configured to be non-reactive with the liner or any other containment material provided in the system.

In some aspects, the PCM can be a material which can be thermally stable for over 10,000 heating and cooling cycles. In some aspects, the PCM can be thermally stable for more than 30 years. It is envisioned that the PCM can be contained within the borehole. In some aspects, PCM containment within the borehole can be achieved via discrete vessels or chambers that are surrounded by a liner filled with one or more of water, grout, or another intermediary. Further holding containment options can comprise one or more PCMs being micro-encapsulated, macro-encapsulated, mixed, a split liner configuration defining multiple chambers to house a plurality of PCMs, and/or two discrete liners within the borehole containing two discrete PCMs. In some aspects, a nested PCM can be included comprising any of a micro-in-macro liner filled with water, grout, or other intermediary, a micro-in-macro liner filled with water, grout, or other intermediary, a micro liner filled with the PCM, a macro liner filled with PCM, or one or more nested liner containing free, macro-encapsulated or micro-encapsulated PCMs.

In further aspects, the system can be anhydrous wherein the borehole only contains PCM. It is envisioned that an anhydrous system can be configured to increase the energy density or thermal capacity of the ground and long-term storage potential. In some aspects, the system comprises one PCM disposed within the borehole. In such an aspect, the system is sectioned into winter and summer sections in a checkerboard array, spiral, radiating array, or other alternating sectioned patterned arrays. In some aspects, the system comprises two or more PCMs that are configured to provide increased latent heat capacity. For example, the PCM can be composed of a dual compound phase change material with a first phase change material and a second phase change material. The system can be simplified by incorporating a dual-temperature PCM wherein the PCM can be configured to have two separate functional temperatures.

The PCM of the system can be configured to absorb heat at a constant temperature. It is envisioned that water can be circulated at more approachable temperatures with such constant heat absorption. Further, the PCM can be configured to prioritize the sensible heat transfer and allow the ground to approach the phase change temperature. In some aspects, the PCM can be operable to recharge on daily/weekly cycles to allow passive heat transfer. While the PCM recharges, the adjacent ground temperature can approach the phase change temperature of the PCM and provide a more even temperature distribution at different radii relative to the borehole. In some aspects, the PCM can be configured to allow the working fluid temperatures to cool and lower the required compressor lift.

A method according to some aspects of the disclosure for providing energy transfer to a structure is herein disclosed. In some aspects, the method can comprise providing the apparatus of the present disclosure. In some aspects, the method can comprise incorporating the apparatus of the present disclosure in a building energy system, wherein the building energy system can be any of, for example and without limitation, HVAC, dehumidification, domestic hot water production, pool heating/cooling/dehumidification, saunas/steam rooms, industrial process heating or cooling, snow/ice melting or external roads/walkways/surfaces, food refrigeration, food preparation/serving, other specialized storage (ex. medicine, life sciences, artifacts) that needs to be temperature controlled, computer/server room cooling, steam production, laundry and dry cleaning, thermal energy networks, ovens/autoclaves, greenhouses/indoor farming. In some aspects, the method can comprise using the apparatus of the present disclosure to provide heat transfer for an article in a building that needs hot or cold fluid. In one aspect, the method can comprise providing a plurality of fluid circuits in communication with an building energy system of a structure, providing a thermal material surrounding the plurality of fluid circuits, providing a barrier surrounding the thermal material, and circulating the fluid between the building energy system and the plurality of fluid circuits. It is envisioned that the method can be operable to provide any of heating, cooling, ventilation, or air conditioning to a structure, such as a building. In some aspects, the method can further comprise the step of providing multiple chambers and/or multiple thermal materials defining distinct thermal properties. The method can further comprise including a heat rejection step between the system and the surrounding earth or a heat absorption step from the surrounding earth. In some aspects, the fluid circuits are subterranean. In other aspects, the fluid circuits are at least partially subterranean having at least a portion thereof above the ground surface. In some aspects, the fluid circuits can comprise a storage system which can be subterranean or above ground. In some aspects, at least one of the components of the present apparatus can be above or partially above ground. In some aspects, the PCM is at least partially subterranean. In some aspects, the fluid loops are at least partially subterranean.

In an exemplary aspect, hot water provided by the building energy system of the structure can be circulated through the system during the day to melt the PCM. The system can be deactivated at night and allow the PCM to reject heat to the ground. Alternatively, cold water or glycol from the building energy system of the structure can be circulated through the system to freeze the PCM. The system can be deactivated at night and allow the PCM to absorb heat from the ground.

In some aspects, the system can be constructed by drilling a borehole, lining the borehole with a liner or casing, installing at least one fluid loop, filling the borehole with a thermal material, capping the borehole with a cap, fusing the cap to the liner or casing, and optionally pressure testing and heat testing the system. The installation of the system can further include a melt-in process of the PCM. The installation of the system can further comprise connecting the system to an building energy system of a structure.

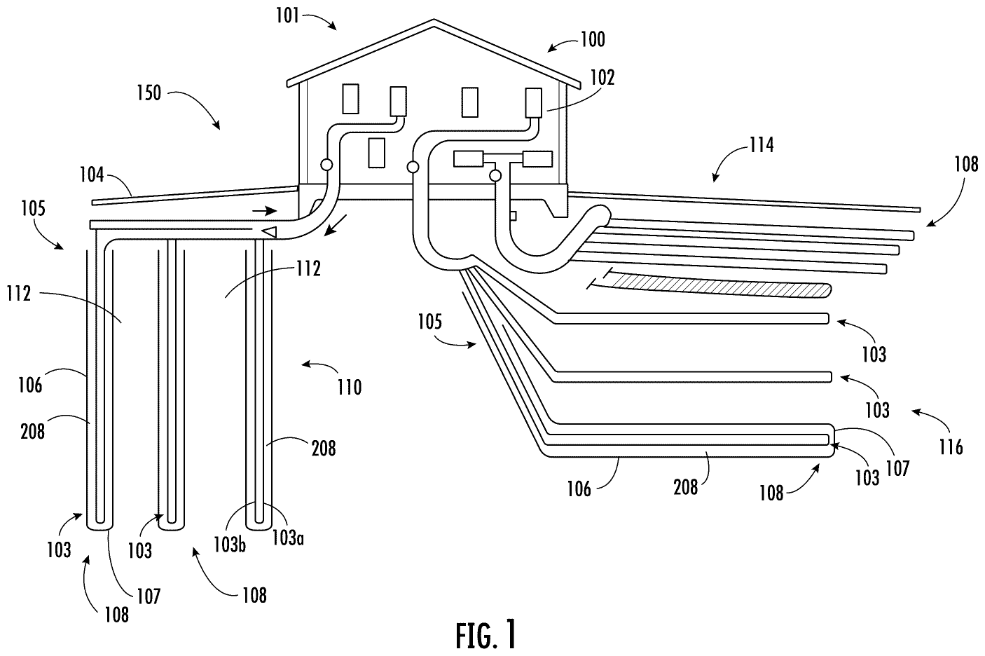

Turning now to FIG. 1, a schematic view of the system in accordance with the current disclosure is provided. The system 100 can include a building energy system 102 in fluid communication with a heat exchange system 150. The building energy system 102 can be associated with a structure 101 such as a building, a house, a commercial building, or any similar building equipped with a building energy system 102, such as an HVAC system which can be operable to provide any of: heating, cooling, air conditioning, or ventilation thereto. The heat exchange system 150 can be disposed external to the building and can include one or more interconnected thermal exchange units 152 in fluid communication with the building energy system 102. A thermal exchange unit 152 includes a borehole 105 that begins at a ground level 104 with side walls 106 extending downwardly therefrom and terminating at an end wall 107. The boreholes 105 can extend up to about 1,000 feet below the ground level 104 in some aspects. In some aspects, the boreholes 105 can extend to about 100 feet below ground level 104. In some aspects, the boreholes 105 can range from a depth range between about 100 feet to about 1,000 feet below ground level 104. In some aspects, the boreholes are subterranean. In some aspects, the boreholes 105 initiate adjacent ground level 104. Extending into each borehole 105 is a conduit forming a fluid loop 103. The system may include one or more fluid loops 103 of conduit configured to circulate a working fluid 118 therein between the building energy system 102 of the structure 101 and the system 100. It is envisioned that the fluid loops 103 can be operable to provide heat transfer between the system 100 and the structure 101. In some aspects, the fluid loops 103 can comprise a hot side 103a and a cold side 103b based on the relative temperature of the working fluid 118. In some aspects, the fluid loops 103 can be structured to extend substantially vertically relative to the ground level 104 and define a U-shaped bend 108 at the lowermost point of the borehole 105. However, as shown in FIG. 1, it is envisioned that the fluid loops 103 can extend in any direction, below ground level 104. In an aspect, the fluid loops 103 are in a vertical array 110, whereby the fluid loops 103 extend downward up to about 1,000 feet below ground level within vertical boreholes 105, and where the fluid loops 103 are vertically spaced and have sub surface material 112 separating the boreholes 105. In an aspect the fluid loops 103 extend laterally from the structure 101 below ground 104 level in a lateral array 114 whereby the fluid loops 103 are at a consistent depth below the ground level 104 are laterally spaced and have sub surface material 112 separating the lateral boreholes. In an aspect, the fluid loops 103 extend laterally from the structure 101 below ground level 104 in a layered array 116 whereby the fluid loops 103 are arranged vertically within lateral runs of boreholes 105 at different depths below ground level 104.

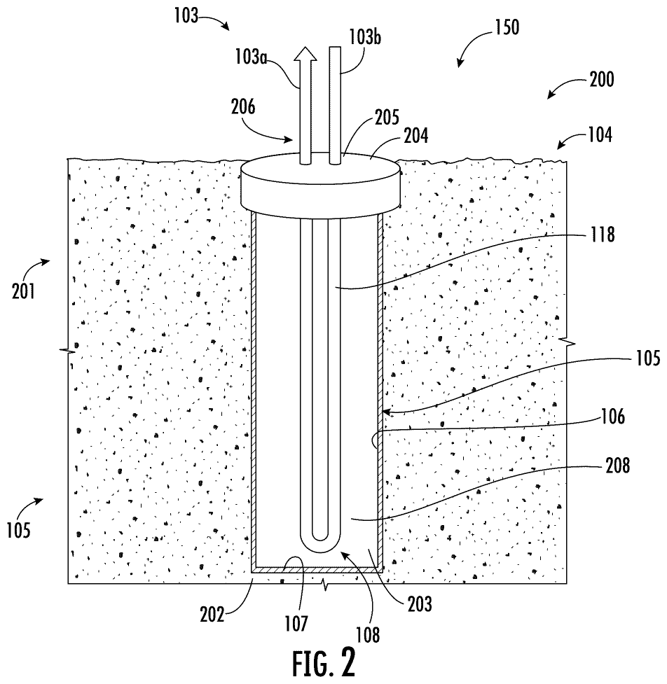

Referring to FIG. 2, a schematic view of a subsection 200 of the system 100 of FIG. 1 is provided in accordance with aspects of the disclosed subject matter. In some aspects, the subsection 200 can comprise the borehole 105 that extends vertically or perpendicularly and downwardly relative to the ground level 104 and is surrounded by subsurface material 112 or earth 201. In some aspects, the borehole 105 contains the fluid loop 103 that follows the downwardly extending profile of the borehole 105. The fluid loop 103 can comprise a surface inlet 205 and a surface outlet 206. In some aspects, the borehole 105 can define an outermost surface which can be lined with a liner 202, with the liner 202 defining a thermal cavity 208. It is envisioned that the liner 202 can be structured to separate the borehole 105 from the surrounding earth 201 and provide only thermal communication therewith. A thermal material 203 can be disposed between the fluid loop 103 and the liner 202. In some aspects, the system can comprise a cap 204 disposed at the uppermost section of the borehole 105. The cap 204 can be configured to provide communication between the fluid loops 103 and can be structured to be substantially impermeable.

Consistent with FIG. 2, the subsection 200 can further comprise a thermal material 203 disposed within the borehole 105. The thermal material can be a PCM. In some aspects, the thermal material 203 substantially fills thermal cavity 208 or void between the liner 202 and the fluid loops 103. In some aspects, the thermal material can provide structural support for the liner 202 and/or the fluid loops 103. In some aspects, the subsection 200 can comprise one or more thermal materials 203 having distinct thermal properties.

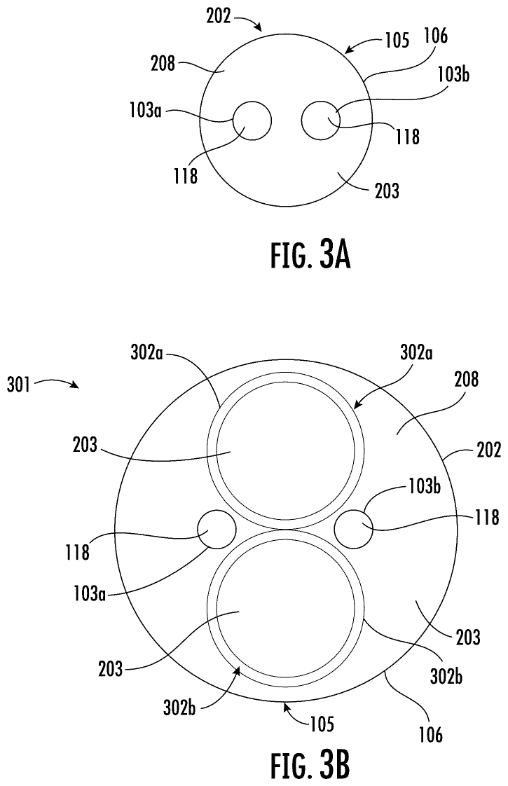

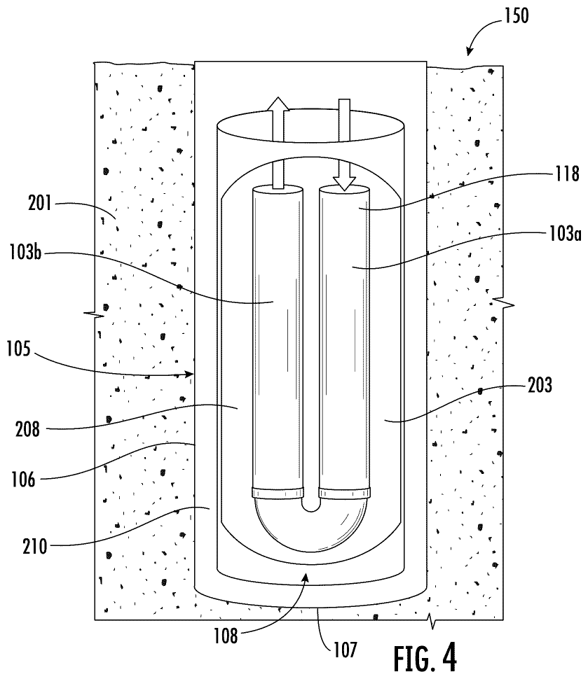

Turning now to FIGS. 3A-B, a top down cross sectional view of a pair of exemplary arrays 300 of exemplary subsections, such as and without limitation the ground level 200 of FIG. 2 is provided in accordance with some aspects of the present disclosure. In some aspects, the system 100 can comprise the borehole 105 that defines an outer perimeter. It is envisioned that the borehole 105 can be substantially circular, although other layouts are contemplated. The outer perimeter of the borehole 105 is engaged by the liner 202 that can be adapted to separate the surrounding earth from the borehole 105. In some aspects, such as shown in the upper array 300 of FIG. 3A, the system comprises thermal material 203 which can be kept separate from the surrounding subsurface material 112 or earth 201 via the liner 202. In some aspects, the system 100 can comprise the fluid loop 103 that comprises the inlet 205 and the outlet 206 (shown in FIG. 2). The fluid loop 103 can travel a route in the borehole 105, for example, with the hot side 103a entering the borehole 105 and descending downward along the side wall 106 in a spiral pattern toward the end wall 107 forming a bend or U-shaped bend 108 adjacent the end wall 107, and with the cold side 103b ascending upward along the side wall 106 in a spiral pattern toward the ground level 104 and exiting the borehole 105. In an implementation the fluid loop 103 can travel a route in the borehole 105, for example, with the hot side 103a entering the borehole 105 and descending downward along the side wall 106 in a spiral pattern toward the end wall 107 forming a bend or U-shaped bend 108 adjacent the end wall 107, and with the cold side 103b ascending upward in the middle of the borehole 105 and exiting the borehole 105 at ground level 104. In such an arrangement, the fluid loop 103 can define a space between each winding of itself. Further, multiple fluid loops 103 (not shown) can be spaced apart from each other to prevent the oversaturation of thermal energy in an area of subsurface material 112 or earth 201. It is envisioned that the array of each system can be configured to reduce thermal saturation, such as spacing the boreholes 105 a sufficient distance apart. In an implementation the array includes a plurality of boreholes 105 spaced about twenty feet to about ten feet on center. In an implementation the array includes a plurality of boreholes 105 spaced twenty feet on center.

Continuing with FIG. 3A, the array 300 can comprises a thermal material 203. The thermal material 203 can be disposed in the borehole 105. In some aspects, the thermal material 203 can be disposed between the liner 202 and the fluid loops 103. In some aspects, the thermal material 203 can substantially encapsulate the fluid loops 103 within the borehole 105 and substantially fill the borehole 105. The array 300 can include a plurality of thermal material 203 having distinct thermal properties. In some aspects, the thermal material 203 can be a PCM.

Referring to FIG. 3B, an alternative aspect of the array 300 is shown as array 301. The array 301 can comprise a fluid loop 103 which can be configured to circulate a fluid therethrough. In some aspects, the fluid loop 103 is in thermal communication with a HVAC system of a building (not shown). In some aspects, the array 301 comprises one or more pipes 302 disposed within the borehole 105. Each pipe 302 can be configured to contain therein a material, such as a thermal material 203 or PCM. As shown, the array 301 can comprise two pipes 302a,b disposed within the borehole 105. The pipes 302 filled with thermal material 203 are operable to provide a thermal condition that enables heat transfer. In some aspects, the array 301 can include a plurality of pipes 302 that each contain therein different thermal material 203 having distinct thermal properties, such as different PCM with different phase change characteristics. The pipes 302a,b can define different sections that each contain a different thermal material 203, so that the different thermal materials 203 are thermally sectioned from each other. The pipes 302 can be arranged within the borehole 105 to tune the heat transfer properties of the borehole 105. In the current aspects, the pipes 302a,b can be arranged in close proximity or contact with the fluid loop 103 to ensure efficient heat transfer between the pipes 302a,b and the fluid loop 103. In some aspects, the borehole 105 can be filled with additional thermal material 203 outside the pipes 302, although in other aspects the borehole 105 can be filled with any other filler.

Referring to FIG. 4, an aspect of the disclosed subject matter is shown and described whereby the system 100 includes a borehole 105 formed within the earth 201, a fluid loop 103 forming a U-bend 108 within a liner 202, and a grout 210 material encasing the liner 202 within the borehole 105. In an implementation the fluid loop 103 formed from a resilient material, such as HDPE or fluorinated ethylene propylene, and the liner 202 is formed from a resilient material, such as fiberglass or metal, such as corrugated metal pipe, or spiral rib pipe. The liner 202 is filled with phase change material 203 that encompasses the fluid loop 103.

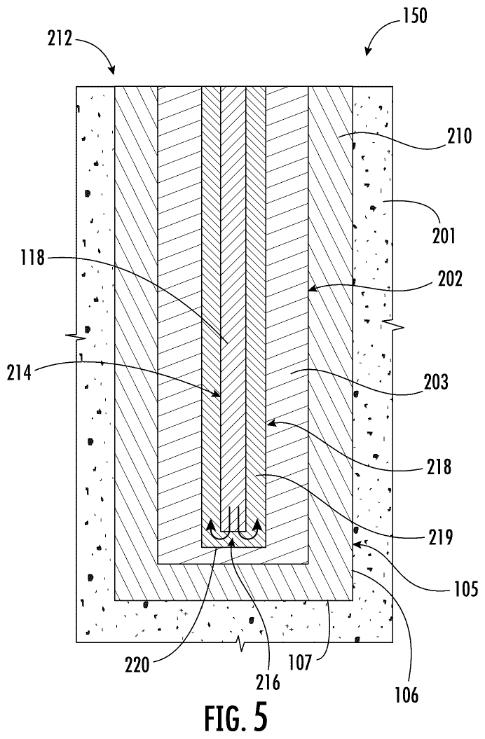

Referring to FIG. 5, an aspect of the disclosed subject matter is shown and described whereby the system 100 alternatively includes a coaxial fluid loop 212 within the liner 202. The coaxial fluid loop 212 is formed by an inner conduit or pipe 214 disposed within a casing cavity 219 formed by an outer casing 218, whereby the working fluid 118 enters the pipe 214 at an inlet and exits the inner pipe 214 at a port 216 and travels upward within the outer casing 218 that extends between a terminal end 220 and the outlet. Similar to the implementation of FIG. 4, the coaxial fluid loop 212 is disposed within a liner 202, and encompassed by thermal material 203, and the liner 202 is within the borehole 105 formed within the earth 201 and encompassed by grout 210. Optionally the outer casing 218 includes structure that aligns the outer casing 218 within the center axis of liner 202.

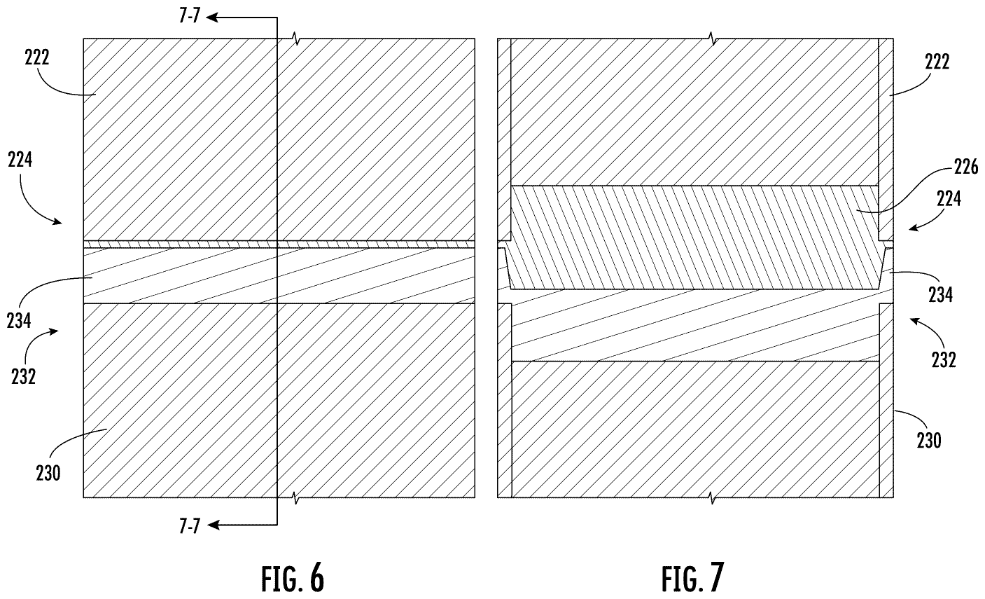

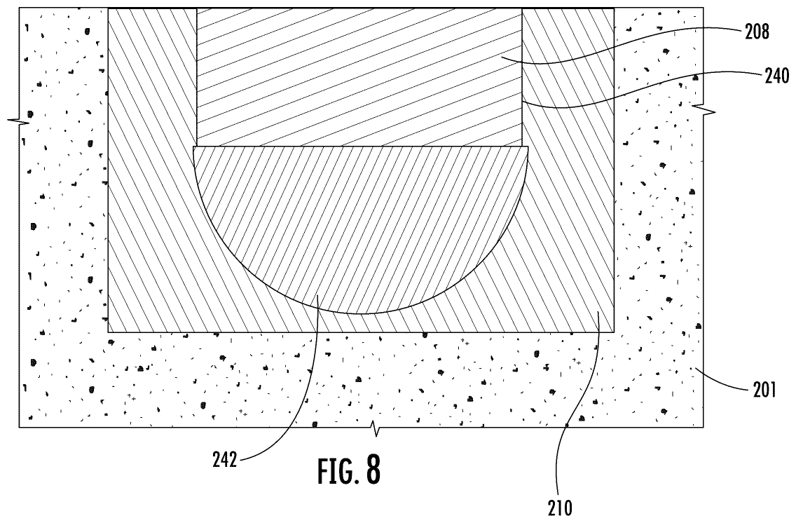

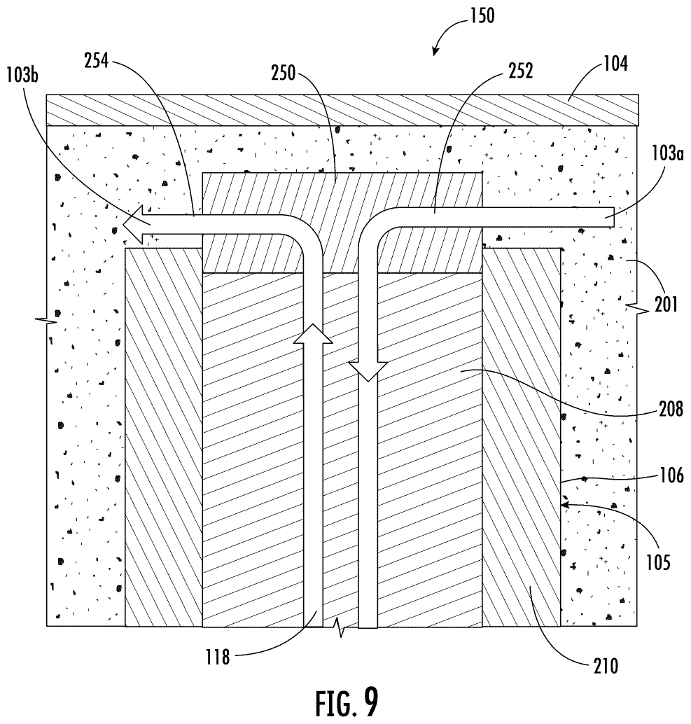

In an implementation, the liner 202 is a casing assembly formed from a plurality of connected segments, such as a first casing 222 and a second casing 230 (FIGS. 6-7). In an implementation, the first casing 222 forms an externally threaded portion 226 at a lower end 224 that threadably engages an internally threaded receiving portion 234 at an upper end 232 of a second casing 230. The terminal or lower casing 240 includes a bottom cap 242 at the lower end. (FIG. 8). The lower casing 240 may optionally include structures that guide the casing assembly during installation into the borehole 105, and that aid in supporting the weight of the casing assembly in contact with the bottom of the borehole 105.

An aspect of the disclosed subject matter includes a header 250 installed at the top of the casing assembly and below finished grade of the ground level 104. The header 250 enables the conduit of the fluid loops 103 of two or more borehole assemblies to be connected together. The header 250 includes a first port 252 for the conduit of the hot side 103a, and a second port 254 for the conduit of the cold side 103b. The header 250 crates an air and watertight seal with the casing assembly. In an implementation, the header 250 includes pressure relief valves, temperature sensors, and other instruments. In an implementation the header 250 is threaded and is threadably joined to the upper-most casing. The header 250 is manufactured from resilient material, including fiberglass, steel, or a mixture of resilient materials

Although the present disclosure has been illustrated and described herein with reference to preferred aspects and specific examples thereof, it will be readily apparent to those of ordinary skill in the art that other aspects and examples may perform similar functions and/or achieve like results. All such equivalent aspects and examples are within the spirit and scope of the present disclosure, are contemplated thereby, and are intended to be covered by the following claims.

It should be emphasized that the above-described aspects are merely possible examples of implementations, merely set forth for a clear understanding of the principles of the present disclosure. Many variations and modifications may be made to the above-described aspect(s) without departing substantially from the spirit and principles of the present disclosure. Further, the scope of the present disclosure is intended to cover any combinations and sub-combinations of all elements, features, and aspects discussed above. All such modifications and variations are intended to be included within the scope of the present disclosure, and all possible claims to individual aspects or combinations of elements or steps are intended to be supported by the present disclosure.

1. A geothermal heat transfer system, comprising:
a heat exchange system, comprising:
a thermal exchange unit, comprising:
a first subterranean borehole;
a liner disposed within the first subterranean borehole, the liner defining a thermal cavity within the borehole;
a conduit disposed within the thermal cavity, the conduit forming an inlet and an outlet; and
a thermal material disposed within the thermal cavity in thermal communication with the liner and the conduit.

2. The system of claim 1, further comprising:
wherein the conduit further comprises:
an outer casing extending from a terminal end within the thermal cavity to the outlet; and
an inner pipe extending from the inlet to a terminal end disposed within the outer casing.

3. The system of claim 1, further comprising:
wherein the liner includes fiberglass.

4. The system of claim 1, further comprising:
a grout disposed between the subterranean borehole and the liner.

5. The system of claim 1, further comprising:
a working fluid within the conduit.

6. The system of claim 1, further comprising:
wherein the thermal material is a phase change material.

7. The system of claim 1, further comprising:
wherein the phase change material is one of: is at least one of: ice pellets, paraffin wax, fatty acids, molten salt, an acid, oleic acid, or any material having a suitable melting or freezing temperature.

8. The system of claim 1, further comprising:
wherein the thermal material comprises:
a first phase change material;
a second phase change material;
wherein the first phase change material can be configured to engage during a heating cycle; and
wherein the second phase change material can be configured to engage during a cooling cycle.

9. The system of claim 1, further comprising:
a building energy system in fluid communication with the heat exchange system.

10. The system of claim 1, further comprising:
a plurality of thermal exchange units; and
wherein the thermal exchange units are fluidly connected.

11. A system comprising:
a subterranean borehole;
a fluid loop having an inlet thereto and an outlet therefrom disposed in the borehole; and
a thermal material disposed in the borehole configured in thermal communication with said fluid loop.

12. The system of claim 11, further comprising a sealed cap disposed at a ground surface of the subterranean borehole, the cap comprises supply and return penetrations for the fluid loop.

13. The system of claim 11, wherein the fluid loops are arranged in an array, the array defining an area between each fluid loop.

14. The system of claim 11, further comprising a liner disposed about a perimeter of the borehole surrounding said fluid loop.

15. The system of claim 14, wherein the liner is formed of a polymeric material.

16. The system of claim 11, wherein the fluid loop is in fluid communication with an apparatus for heating, ventilating, and air conditioning a building, and the fluid loop is substantially vertical.

17. The system of claim 11, wherein, the thermal material is a phase change material.

18. The system of claim 17, wherein the phase change material is at least one of: ice pellets, paraffin wax, fatty acids, molten salt, an acid, oleic acid, or any material having a suitable melting or freezing temperature.

19. The system of claim 11, wherein the system is configured to function with a heat pump.

20. The system of claim 11, wherein the fluid loop defines a hot side and a cold side.

21. The system of claim 11, wherein the liner is substantially flexible.

22. The system of claim 11, wherein the thermal material can be configured to enhance heat transfer between the fluid loop and the surrounding earth.

23. The system of claim 11, wherein the thermal material is a dual compound phase change material comprising a first phase change material and a second phase change material.

24. The system of claim 23, wherein the system is sectioned into a thermally separate first section and a second section, the first section comprises the first phase change material and can be configured to function at a first temperature, and the second section comprises the second phase change material and can be configured to function at a second temperature.

25. The system of claim 11, wherein the thermal material can be configured to melt and freeze.

26. The system of claim 11, wherein the thermal material comprises a first phase change material and a second phase change material having distinct thermal properties, the first phase change material can be configured to engage during a heating cycle, and the second phase change material can be configured to engage during a cooling cycle.

27. A method of providing building energy transfer to a structure, the method comprising:
providing a plurality of fluid circuits in communication with a building energy system in fluid communication with the structure;
providing a thermal material surrounding the plurality of fluid circuits;
providing a barrier surrounding the thermal material; and
circulating a fluid between the building energy system and the plurality of fluid circuits.

28. The method of claim 27, further comprising:
a subterranean borehole;
wherein each fluid circuit include a loop having an inlet thereto and an outlet therefrom disposed in the borehole; and
wherein the thermal material is disposed in the borehole configured in thermal communication with said fluid circuit; and
wherein the building energy system provides heating, ventilating, and air conditioning for the structure.

29. The method of claim 27, further comprising the steps of providing multiple chambers within the borehole.

30. The method of claim 27, wherein cooling is achieved via a heat rejection step comprising melting the thermal material and rejecting heat to the surrounding earth.

31. The method of claim 27, wherein heating is achieved via a heat addition step comprising freezing the thermal material and absorbing heat from the surrounding earth.

32. The method of claim 27, wherein the fluid circuits are subterranean.
